(19) United States
(12) Patent Application Publication
(10) Pub. No.: US 2022/0381060 A1
(43) Pub. Date: Dec. 1, 2022

(54) STORAGE DEVICE FOR KEY

(71) Applicant: ASSA ABLOY AB, Stockholm (SE)

(72) Inventor: Teodor JOHNSSON, Halmstad (SE)

(21) Appl. No.: 17/642,796

(22) PCT Filed: Sep. 3, 2020
(86) PCT No.: PCT/EP2020/074549

§ 371 Date: Mar. 14, 2022

(30) Foreign Application Priority Data
Sep. 18, 2019 (EP) 19198041.6

(51) Int. Cl. E05B 19/00; E05B 47/00

(52) U.S. Cl. CPC E05B 19/0005; E05B 47/0012; E05B 2047/0058; E05B 2047/0095

(57) ABSTRACT

A storage device (10) for storing a key, the storage device (10) comprising a housing (12, 38); a blocking structure (40); a carrier (18) for carrying 76 a key, the carrier (18) being movable relative to the housing (12, 38) between a closed position (20), in which the carrier (18) is accommodated within the housing (12, 38), and an open position (26), in which the carrier (18) at least partly protrudes from the housing (12, 38) for retrieval of a key from the carrier (18), the carrier (18) comprising a blocking member (44) and a biasing device (42) arranged to bias the blocking member (44) into engagement with the blocking structure (40) in the closed position (20); and an actuator (52) comprising a locking structure (54), the actuator (52) being arranged to move the locking structure (54) between a 40 locking position (56) to lock the blocking member (44) when engaging the blocking structure (40), and an unlocking position (84) in which the blocking member (44) is not locked by the locking structure (54).

### TECHNICAL FIELD

The present disclosure generally relates to storage devices for keys. In particular, a storage device comprising a blocking member arranged in a carrier, and a storage device comprising at least one securing element, are provided.

### BACKGROUND

Key storage devices may be used for safe handling of keys in order to prevent theft of the keys. For example, a caregiver may be given access to a physical key stored in the key storage device in order to access a restricted area by means of the physical key. For a caregiver visiting several persons every day, the administration around safe handling of keys is cumbersome, and the security is always an issue. Furthermore, an increasingly common need is to be able to give controlled access to individuals on a temporary basis, for example if a person has offered to water plants or take care of animals during a trip. By means of a key storage device configured to electronically lock away the physical key, an authorized person can be electronically identified and allowed to access the physical key.

EP 2372068 A2 discloses a lockable enclosure comprising a housing and a loading cartridge assembled with the housing. The loading cartridge is vertically slidable between a secured state in which a recess of the loading cartridge cannot be accessed through a bottom opening of the housing, and an access position in which at least a portion of the recess extends through at least a portion of the opening, such that a storable item may be withdrawn from the recess.

### SUMMARY

Key storage devices may require regular maintenance, such as replacement of a battery or wear parts. A key storage device may be located in harsh conditions which may further increase maintenance requirements. The key storage device may for example subjected to high temperatures, freezing temperatures, heavy rain, moisture, sand and dirt.

Some key storage devices are also complicated to install. The installation is particularly tiresome if many key storage devices are to be installed.

One object of the present disclosure is to provide a storage device for a key, which storage device has a simple design.

A further object of the present disclosure is to provide a storage device for a key, which storage device is cheap.

A further object of the present disclosure is to provide a storage device for a key, which storage device has a durable design.

A further object of the present disclosure is to provide a storage device for a key, which storage device has a reliable operation.

A further object of the present disclosure is to provide a storage device for a key, which storage device enables a carrier to be locked in a closed position without having to manually operate a latch.

A still further object of the present disclosure is to provide a storage device for a key, which storage device facilitates maintenance of the storage device, e.g. without tools.

A still further object of the present disclosure is to provide a storage device for a key, which storage device facilitates replacement of a battery, e.g. without tools.

A still further object of the preset disclosure is to provide a storage device for a key, which storage device can easily be mounted to, and/or easily be dismounted from, a wall or door.

A still further object of the preset disclosure is to provide a storage device for a key, which storage device solves several or all or the foregoing objects in combination.

According to one aspect, there is provided a storage device for a key, the storage device comprising a housing; a blocking structure; a carrier for carrying a key, the carrier being movable relative to the housing between a closed position, in which the carrier is accommodated within the housing, and an open position, in which the carrier at least partly protrudes from the housing for retrieval of a key from the carrier, the carrier comprising a blocking member and a biasing device arranged to bias the blocking member into engagement with the blocking structure in the closed position; and an actuator comprising a locking structure, the actuator being arranged to move the locking structure between a locking position to lock the blocking member when engaging the blocking structure, and an unlocking position in which the blocking member is not locked by the locking structure.

By means of the biasing device arranged to bias the blocking member into engagement with the blocking structure in the closed position of the carrier, the carrier can be held stationary by the blocking member while driving the actuator to move the locking structure. Thereby, a manually operable latch for locking the carrier in the closed position can be dispensed with. As a consequence, the storage device can be made simpler and cheaper.

The blocking member and the biasing device are provided in the carrier and thus move together with the carrier between the closed position and the open position. Due to the provision of the biasing device in the carrier, the biasing device and/or the blocking member can be accessed when the carrier adopts the open position or when the carrier is removed from the housing. The storage device does not have to be disassembled with tools in order to replace the biasing device and/or the blocking member. Thereby, maintenance of the storage device is facilitated.

If access is granted, an electric motor of the actuator may be driven to move the locking structure from the locking position to the unlocking position. If access is denied, the electric motor may not be driven. The blocking member, the biasing device and the actuator form a lock device for selectively locking the carrier in the closed position.

The blocking member and/or the housing may for example be made of metal or other hard material. The housing may for example comprise an inner housing and an outer housing fixed with respect to each other. The blocking structure may be provided in the housing. In any case, both the blocking structure and the housing may be stationary.

The carrier may comprise a compartment for accommodation of one or more physical keys. The actuator may in some implementations comprise a piston. The piston may be connected to the locking structure, or may constitute the locking structure. The actuator may be an electric actuator, e.g. comprising an electric motor for driving the locking structure.

The blocking member may be arranged to be disengaged from the blocking structure by moving the carrier from the closed position towards the open position when the locking structure adopts the unlocking position. The engagement between the blocking member and the blocking structure can be released by manually pulling the carrier.

The carrier may comprise a seat. In this case, the biasing device may be arranged to bias the blocking member away from the seat, and a free space for receiving the locking structure may be established between the seat and the blocking member at least when the blocking member engages the blocking structure. Due to this free space, the locking structure can be moved to the locking position without interference with the blocking member. Furthermore, the locking structure can be maintained in the locking position without any forces acting thereon. The rating or dimensioning of the actuator can thereby be reduced. However, in some implementations, the locking structure may be used to add a pushing force on the blocking member into engagement with the blocking structure.

The biasing device may comprise a spring. The spring may be a compression spring, for example a coil spring. Alternatively, the biasing device may comprise a magnet. For example, two repelling magnets may be arranged bias the blocking member into engagement with the blocking structure.

The blocking member may comprise an elongated and curved engaging surface arranged to engage the blocking structure. In this case, the carrier may be movable between the closed position and the open position along a carrier line, and the engaging surface may be elongated in a direction substantially perpendicular to, or perpendicular to, the carrier line. In addition, the engaging surface may be elongated in a direction substantially parallel with, or parallel with, a height direction of the carrier.

The blocking member may be a cylinder, for example a metal cylinder. In case the biasing device comprises a spring, the cylinder may comprise an opening for receiving the spring. Alternatively, or in addition, the blocking member may be connected to a pin.

A shape of the blocking structure may substantially conform to, or conform to, a shape of the blocking member. Alternatively, or in addition, the blocking structure may be a blocking recess.

The carrier may comprise a side wall. In this case, the blocking member may protrude with respect to the side wall when engaging the blocking structure.

The biasing device may be arranged to bias the blocking member evenly into engagement with the blocking structure. Thereby, the engagement of the blocking structure by means of the blocking member can be improved and the carrier can be held more strongly in the closed position.

The blocking member may be linearly guided relative to the seat between an engaging position, in which the blocking member engages the blocking structure, and a disengaging position, in which the blocking member is disengaged from the blocking structure. To this end, the carrier may comprise a pin guided through an opening in the seat, and connected to the blocking member. The seat may extend in a plane parallel with the carrier line. In this way, the biasing device can be arranged to bias the blocking member evenly into engagement with the blocking structure.

The locking structure may comprise at least one locking member and at least one biasing member. According to one variant, the locking structure comprises two locking members. In this case, the biasing device may be arranged between the two locking members when the blocking member engages the blocking structure and the locking structure adopts the locking position. Also in this way, the biasing device can be arranged to bias the blocking member evenly into engagement with the blocking structure.

Alternatively, the biasing device may comprise two biasing members. In this case, the locking structure may be arranged between the two biasing members when the blocking member engages the blocking structure and the locking structure adopts the locking position. Also in this way, the biasing device can be arranged to bias the blocking member evenly into engagement with the blocking structure.

The housing may comprise a holding structure. In this case, the biasing device may be arranged to bias the blocking member into engagement with the holding structure in the open position. When the holding structure is engaged by the blocking member, the carrier is prevented from falling out from the housing. The holding structure may be stationary.

The holding structure may be of the same type as the blocking structure, i.e. arranged to be engaged by the blocking member. Alternatively, the blocking member may comprise an engaging structure having an aperture arranged to engage a holding structure having a tab provided in an opening in a side wall of the housing. In this case, the aperture may latch onto the tab such that the blocking member is brought into engagement with the holding structure. The tab may be parallel with the side wall.

In case the carrier comprises a pin guided through an opening in the seat, and connected to the blocking member, a free end of the pin may protrude from the seat on a side of the seat opposite to the blocking member. This free end may be manipulated (e.g. by fingers of a user), in order to pull the blocking member out from engagement with the blocking structure, provided that the locking structure does not lock the blocking member.

Alternatively, the blocking member and the blocking structure may be configured such that the force of the biasing device can be overcome by manually pulling the carrier. Also in this way, the carrier can be entirely separated housing, e.g. for replacing the biasing device and/or the blocking member.

According to a further aspect, there is provided a storage device for a key, which storage device comprises a base structure for being fastened to a wall or door, the base structure having a securing structure; a housing; at least one securing element arranged to adopt a released state where the housing is allowed to be released from the base structure by disengagement between the at least one securing element and the securing structure, and a secured state where the housing is secured to the base structure by engagement between the at least one securing element and the securing structure; and a carrier for carrying a key, the carrier being movable relative to the housing between a closed position, in which the carrier is accommodated within the housing, and an open position, in which the carrier at least partly protrudes from the housing for retrieval of a key from the carrier, wherein the at least one securing element is arranged to be switched from the released state to the secured state by movement of the carrier from the open position towards the closed position. When switching between the released state to the secured state, the securing element may move between a released position to a secured position, e.g. in a respective guiding structure of the housing.

Thus, by merely closing the storage device, e.g. by pushing the carrier from the open position to the closed position, the housing can be automatically secured to the base structure. When the carrier adopts the closed position, the carrier may block the at least one securing element. In this way, the at least one securing element can be prevented from being switched or moved from the secured state to the released state. The housing and the carrier can thereby be secured to the base structure without screws.

Furthermore, by opening the storage device, e.g. by pulling the carrier from the closed position to the open position, the carrier may no longer block the at least one securing element. The housing, and all parts attached thereto, can then be removed from the base structure by grabbing and pulling the housing. Replacement of a battery can thereby be facilitated.

Each securing structure may comprise a groove associated with each securing element. Each guiding structure may comprise a track for guiding an associated securing element.

The base structure may for example comprise a base plate. The base structure can be permanently installed to a wall or door, for example by means of screws or other fastening elements.

Each of the at least one securing element may comprise a locking bar. The one or more locking bars may be oriented in a width direction of the storage device, i.e. perpendicular to the carrier line.

The carrier may be movable between the closed position and the open position along a carrier line, and the at least one securing element may be arranged to be moved to a secured position in a direction substantially perpendicular to, or perpendicular to, the carrier line. In addition, the at least one securing element may be arranged to be moved in a direction parallel with, or parallel with, a height direction of the carrier.

The carrier may be movable between the closed position and the open position along a carrier line, and the carrier may comprise an inclined surface, inclined with respect to the carrier line, and arranged to engage the at least one securing element during movement of the carrier from the open position towards the closed position. The inclined surface may be provided on a chamfered portion of the carrier.

The storage device may further comprise a slidable structure slidable relative to the base structure. The slidable structure may be fixed with respect to the housing, and the slidable structure may comprise at least one slidable structure recess for at least partly receiving the at least one securing element in the secured state. By moving the housing relative to the base structure when the at least one securing element is in the secured state, the at least one securing element will move along with the housing and will thereby be forced to leave the respective slidable structure recess.

The slidable structure may be engaged with the base structure by means of steps. For example, the slidable structure may comprise two elongated portions engaging steps on the base structure.

The storage device of both aspects may or may not be combined. Although the storage device according to the present disclosure is mainly exemplified as a key storage device, the storage device can be used to electronically provide selective access to items other than a key.

### BRIEF DESCRIPTION OF THE DRAWINGS

Further details, advantages and aspects of the present disclosure will become apparent from the following embodiments taken in conjunction with the drawings, wherein:

FIG. 1: schematically represents a perspective front view of a key storage device with a carrier in a closed position;

FIG. 2: schematically represents a perspective front view of the key storage device where the carrier is in an open position;

FIG. 3: schematically represents a perspective rear view of the key storage device where the carrier is in the closed position;

FIG. 4: schematically represents a partial perspective front view of the key storage device where the carrier is in the closed position and a locking structure is in a locking position;

FIG. 5: schematically represents a partial front view of the key storage device in FIG. 4;

FIG. 6: schematically represents a partial front view of the key storage device where the carrier is in the closed position and the locking structure is in an unlocking position;

FIG. 7: schematically represents a partial front view of the key storage device where the carrier is in the open position and the locking structure is in the unlocking position;

FIG. 8: schematically represents a perspective view of the key storage device in FIG. 7;

FIG. 9: schematically represents a partial cross-sectional side view of the key storage device where the carrier is in the open position and two securing elements are in a released state; and

FIG. 10: schematically represents a partial cross-sectional side view of the key storage device where the carrier is in the closed position and the two securing elements are in a secured state.

### DETAILED DESCRIPTION

In the following, a storage device comprising a blocking member arranged in a carrier, and a storage device comprising at least one securing element, will be described. The same reference numerals will be used to denote the same or similar structural features.

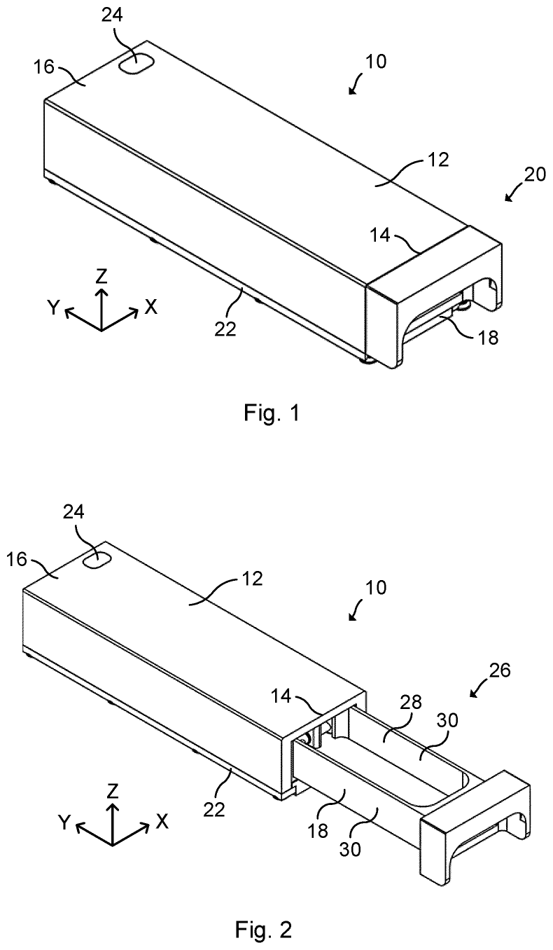

FIG. 1 schematically represents a perspective front view of a storage device 10. The storage device 10 may for example be mounted to a wall in proximity to a door.

The storage device 10 of this example comprises an outer housing 12. The outer housing 12 may for example be made of metal. The outer housing 12 comprises a proximal end 14 and a distal end 16.

The storage device 10 further comprises a carrier 18. The carrier 18 can carry a physical key. In FIG. 1, the carrier 18 is in a closed position 20. In the closed position 20, the carrier 18 is accommodated within the outer housing 12 such that the key cannot be accessed.

The storage device 10 further comprises a slidable structure, here exemplified as a pair of rails 22 (only one rail 22 is visible in FIG. 1). The rails 22 are permanently secured to the outer housing 12, for example by fasteners.

The storage device 10 of this example further comprises a light emitting diode (LED) 24. The LED 24 is visible through an opening (not denoted) in the outer housing 12. The LED 24 can be used to provide various indications of the storage device 10.

FIG. 1 further shows a Cartesian coordinate system for reference purposes. The storage device 10 may however be oriented arbitrarily in space.

FIG. 2 schematically represents a perspective front view of the storage device 10. In FIG. 2, the carrier 18 is in an open position 26. In the open position 26, the carrier 18 protrudes from the outer housing 12.

The carrier 18 comprises a compartment 28. One or more physical keys can be accommodated in the compartment 28. In the open position 26 of the carrier 18 in FIG. 2, the one or more physical keys can be collected from, or be leaved to, the compartment 28. FIG. 2 further shows that the carrier 18 comprises two side walls 30.

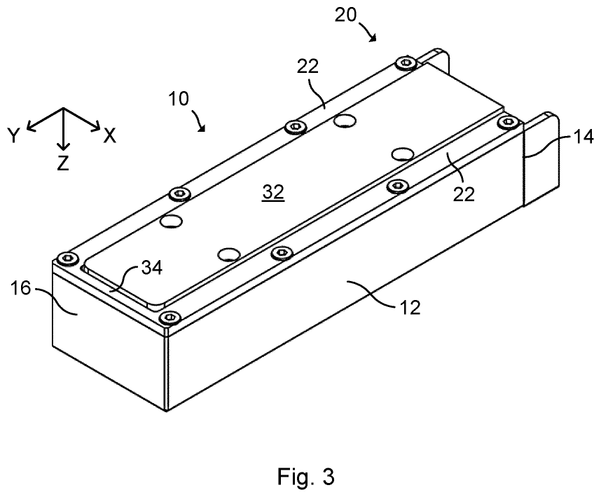

FIG. 3 schematically represents a perspective rear view of the storage device 10. In FIG. 3, the carrier 18 is in the closed position 20.

As shown in FIG. 3, the storage device 10 comprises a base structure, here exemplified as a base plate 32. The base plate 32 can be permanently secured to a wall or door, for example by means of screws or other fastening elements.

In the illustrated mounted state of the storage device 10, the outer housing 12 is closed by the base plate 32. FIG. 3 further shows both rails 22 of the slidable structure. All parts of the storage device 10 can be removed from the base plate 32 by sliding these parts relative to the base plate 32. In the example in FIG. 3, one end of both rails 22 are joined by a bridging portion 34.

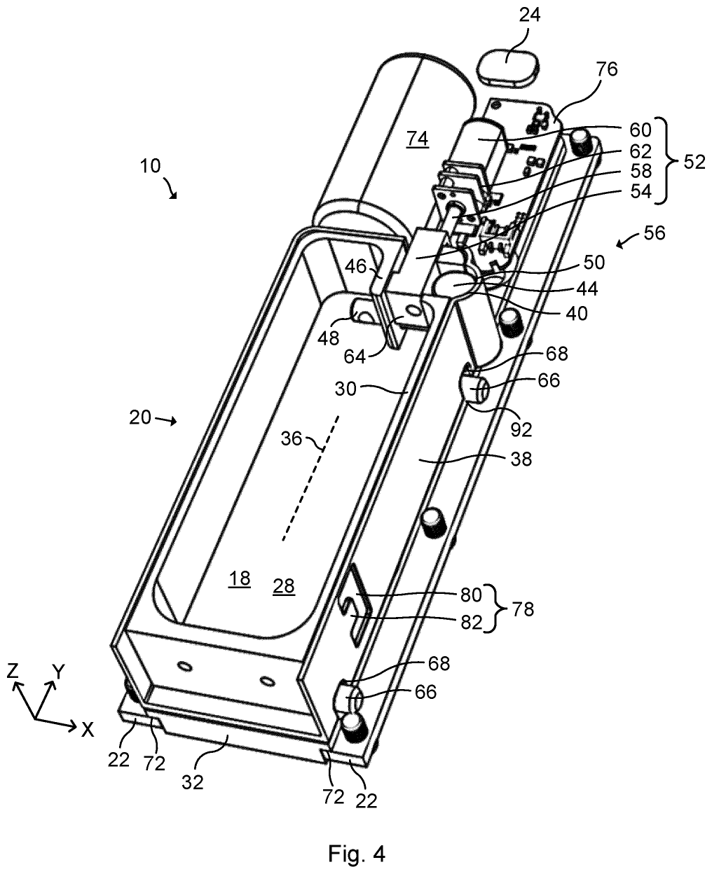

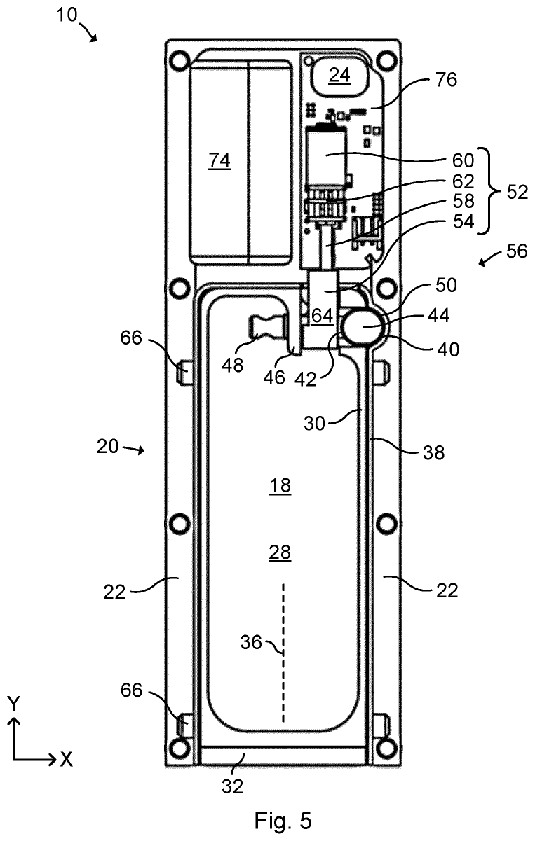

FIG. 4 schematically represents a partial perspective front view of the storage device 10. FIG. 5 schematically represents a partial front view of the storage device 10 in FIG. 4. With collective reference to FIGS. 4 and 5, the carrier 18 is in the closed position 20. FIGS. 4 and 5 further show a carrier line 36. The carrier 18 can move along the carrier line 36 between the closed position 20 and the open position 26.

As shown in FIGS. 4 and 5, the storage device 10 of this example further comprises an inner housing 38. The inner housing 38 is fixed with respect to the outer housing 12. The inner housing 38 may for example be made of plastic and the outer housing 12 may for example be made of metal.

The use of both an inner housing 38 and an outer housing 12 is optional. For example, the inner housing 38 and the outer housing 12 may be integrally formed to provide a joint housing.

The storage device 10 further comprises a blocking structure, here exemplified as a blocking recess 40. The blocking recess 40 is provided in the inner housing 38.

The carrier 18 comprises a biasing device, here exemplified as a compression coil spring 42. The carrier 18 further comprises a blocking member, here exemplified as a cylinder 44. The cylinder 44 may for example be made of metal.

The storage device 10 comprises a seat 46. In FIGS. 4 and 5, the spring 42 is compressed between the seat 46 and the cylinder 44. Thereby, the spring 42 forces the cylinder 44 away from the seat 46 and into engagement with the blocking recess 40. In this state, the cylinder 44 protrudes partly with respect to the side wall 30 of the carrier 18 (to the right in FIGS. 4 and 5). In case the inner housing 38 is made of plastic, at least the blocking recess 40 may be provided with a metal layer, i.e. such that the cylinder 44 engages with a metal part of the inner housing 38.

The storage device 10 further comprises a pin 48. The pin 48 extends through an opening (not denoted) in the seat 46. The pin 48 can move linearly in the opening. The cylinder 44 is connected to the pin 48, to a right side of the pin 48 in FIGS. 4 and 5. The cylinder 44 is thereby guidable relative to the seat 46 between the illustrated engaging position, where the cylinder 44 engages the blocking recess 40, and a disengaging position (to the left in FIGS. 4 and 5), where the cylinder 44 is disengaged from the blocking recess 40. In this example, the spring 42 encircles the pin 48.

In the closed position 20, the carrier 18 is positioned such that the cylinder 44 is aligned with the blocking recess 40, i.e. aligned along the carrier line 36. When the cylinder 44 engages the blocking recess 40, a free space is formed between the cylinder 44 and the seat 46.

The cylinder 44 comprises an engaging surface 50. As shown in FIGS. 4 and 5, the engaging surface 50 of the cylinder 44 is in direct contact with the blocking recess 40. Due to the cylindrical shape, the engaging surface 50 is elongated and curved. The engaging surface 50 is elongated in a height direction of the carrier 18, i.e. perpendicular to the carrier line 36. The blocking recess 40 has a shape, size and orientation corresponding to the engaging surface 50.

The storage device 10 further comprises an actuator 52. The actuator 52 comprises a locking structure 54. In FIGS. 4 and 5, the locking structure 54 is in a locking position 56. In the locking position 56, the locking structure 54 prevents the cylinder 44 from being disengaged from the blocking recess 40. The locking structure 54 can freely move in the free space between the cylinder 44 and the seat 46 without needing to push the cylinder 44.

In this example, the actuator 52 further comprises a shaft 58, an electric motor 60 and a gearbox 62. By driving the electric motor 60, the shaft 58 can be rotated. The locking structure 54 is threadingly engaged with the shaft 58. Thus, the locking structure 54 translates linearly when the shaft 58 is rotated.

The locking structure 54 of this example comprises one locking member 64. In this example, the locking member 64 has a square-shaped cross-section. The locking member 64 may alternatively have for example a circular cross-section.

In the illustrated locking position 56 of the locking structure 54, the spring 42 is positioned below the locking member 64. In FIGS. 4 and 5, the locking member 64 is not in contact with the cylinder 44. However, the cylinder 44 is locked by the locking member 64. That is, locking member 64 prevents the cylinder 44 from being moved to the left in FIGS. 4 and 5.

Due to the compression of the spring 42, the spring 42 applies a force onto the cylinder 44 (to the right in FIGS. 4 and 5). The force is applied at a center point of the cylinder 44, i.e. at half the height of the cylinder 44. Moreover, the cylinder 44 is guided by being connected to the pin 48, which in turn is guided in the opening in the seat 46. Thereby, the spring 42 forces the cylinder 44 evenly into engagement with the blocking recess 40.

The storage device 10 further comprises two securing elements, here exemplified as two locking bars 66. Each locking bar 66 is oriented perpendicular to the carrier line 36 and parallel with the width direction of the carrier 18.

As can be seen in FIG. 4, the inner housing 38 further comprises two guiding structures, here exemplified as tracks 68. Two similar tracks 68 are also provided on the opposite side of the inner housing 38. Each track 68 is linear and extends in the height direction of the carrier 18, i.e. in the Z-direction. Each locking bar 66 is guided in two associated tracks 68.

Furthermore, each rail 22 may comprise two slidable structure recesses or rail recesses. Each locking bar 66 may be engaged in a rail recess on each side of the carrier 18, such that the locking bars 66 are partly received in the rail recesses.

As shown in FIG. 4, the base plate 32 comprises two steps 72. Each rail 22 is seated in a respective step 72. In this way, the rails 22, and the parts connected thereto, are prevented from being moved in the Z-direction.

The storage device 10 further comprises a battery 74. The storage device 10 further comprises a control system, here implemented as a printed circuit board (PCB) 76. The PCB 76 is integrated with the electric motor 60. The PCB 76 and the electric motor 60 are powered by the battery 74.

The PCB 76 may be configured to determine whether or not authorization should be granted based on an access signal. The PCB 76 may be arranged to communicate wirelessly with an external device, such as a mobile phone. The wireless communication may for example be carried out by means of BLE (Bluetooth Low Energy) or RFID (Radio Frequency Identification). As an alternative to wireless communication, a user may input a code to the PCB 76, for example via a keypad.

If an authorization request is denied, the electric motor 60 is not driven, i.e. the locking structure 54 remains in the locking position 56 according to FIGS. 4 and 5. If an authorization request is granted, e.g. if a valid credential is presented, the PCB 76 drives the electric motor 60 to move the locking structure 54 from the locking position 56 in FIGS. 4 and 5 to an unlocking position.

The inner housing 38 further comprises a stationary holding structure 78. The holding structure 78 is provided in the side wall 30. The cylinder 44 engages the holding structure 78 when the carrier 18 is in the open position 26. The holding structure 78 of this example comprises an opening 80 and a tab 82 in the opening 80. The holding structure 78 is arranged between the locking bars 66.

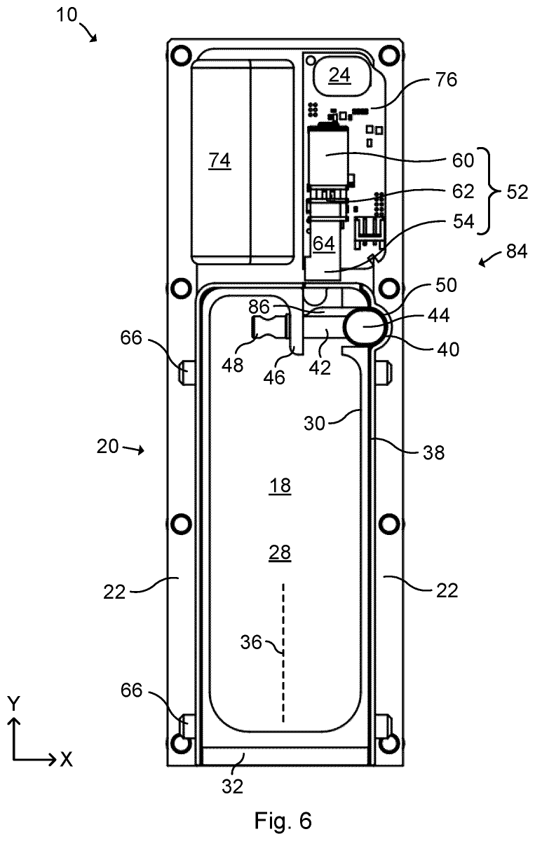

FIG. 6 schematically represents a partial front view of the storage device 10. In FIG. 6, the actuator 52 has driven the locking structure 54 to an unlocking position 84. The carrier 18 is still in the closed position 20.

The locking structure 54 has moved in parallel with the carrier line 36 between the locking position 56 and the unlocking position 84. In FIG. 6, the free space 86 between the seat 46 and the cylinder 44 can be seen more clearly. The movement of the locking structure 54 in the free space 86 is made with light force, in comparison with if contacting the cylinder 44.

In the unlocking position 84, the locking structure 54 no longer blocks the cylinder 44. However, as shown in FIG. 6, the cylinder 44 is maintained in engagement with the blocking recess 40 by the spring 42. By means of the spring 42 and the cylinder 44, the carrier 18 can be held stationary relative to the inner housing 38 when the locking structure 54 is driven from the locking position 56 to the unlocking position 84, and vice versa. A latch, for example operated by a turning handle, used for holding the carrier 18 in the closed position 20 can thereby be dispensed with.

The storage device 10 may further comprise a position sensor arrangement for sensing the locking position 56 and/or the unlocking position 84 of the locking structure 54. The position sensor arrangement may for example comprise a magnet (not shown) provided on the locking structure 54 and a stationary sensor (not shown) for sensing proximity of the magnet. The status of the actuator 52, e.g. the adoption of the locking position 56 and/or the unlocking position 84 by the locking structure 54, may be communicated to the exterior of the storage device 10. For example, the LED 24 may visually indicate (e.g. by light, or by light of a particular color) a particular status of the actuator 52 and/or the locking structure 54.

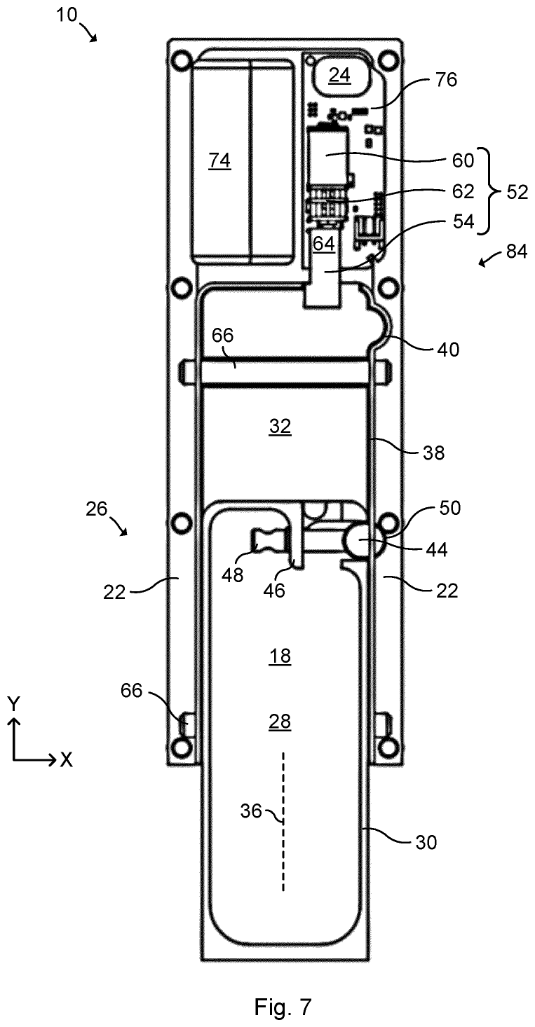

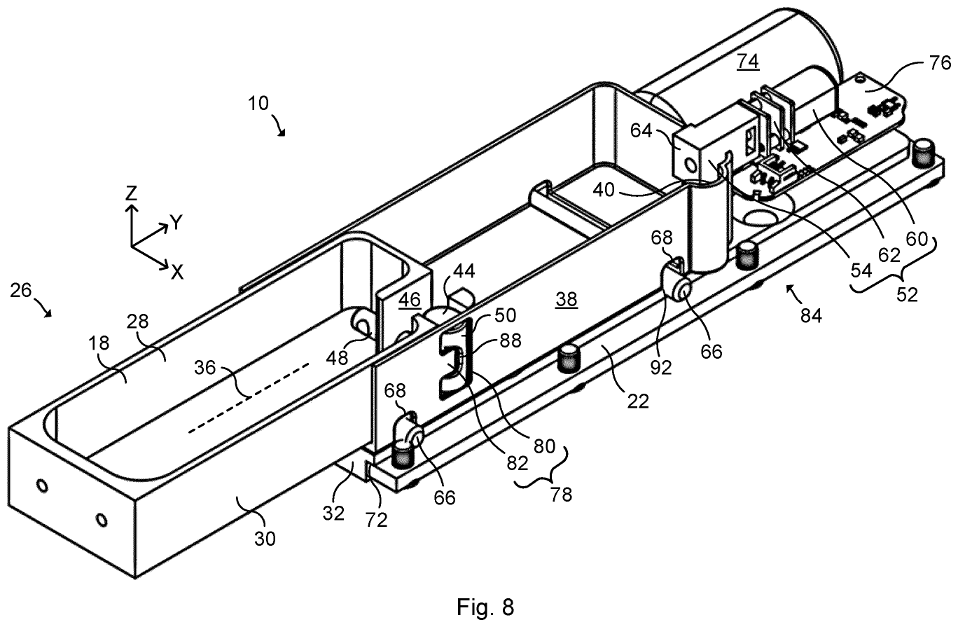

FIG. 7 schematically represents a partial front view of the storage device 10. FIG. 8 schematically represents a perspective view of the key storage device 10 in FIG. 7. With collective reference to FIGS. 7 and 8, the carrier 18 is in the open position 26 and the locking structure 54 is still in the unlocking position 84.

When the carrier 18 is in the closed position 20 and the locking structure 54 is in the unlocking position 84, the carrier 18 can be manually pulled from the closed position 20 in FIG. 6 to the open position 26 in FIGS. 7 and 8. During this movement of the carrier 18, the cylinder 44 is forced out from the blocking recess 40 against the force of the spring 42.

As shown in FIG. 8, the cylinder 44 comprises an engaging structure, here exemplified as an aperture 88. The aperture 88 latches onto the tab 82 of the holding structure 78. When the holding structure 78 is engaged by the cylinder 44, as illustrated in FIG. 8, the carrier 18 is prevented from falling out from the inner housing 38.

In order to pull the carrier 18 further from the open position 26 in FIGS. 7 and 8, the pin 48 may be manually moved (to the left in FIG. 7) such that the cylinder 44 adopts the disengaging position. The carrier 18 may then be pulled until the carrier 18 is entirely separated from the inner housing 38. Thereby, the spring 42 and/or the cylinder 44 can be easily accessed and replaced without needing any tools. As particularly seen in FIG. 7, it can also be noted that the carrier 18 of this example does not comprise any electronics.

By engagement of the holding structure 78 with the cylinder 44, the carrier 18 can be held in an open position 26. This may for example be useful if the storage device 10 is mounted vertically to prevent the carrier 18 to fall out from the storage device 10 by gravity.

After collecting a key from the carrier 18, the carrier 18 can be manually closed and the above procedure can be reversed. Thus, the carrier 18 can be inserted into the inner housing 38, and pushed from the open position 26 to the closed position 20 where the cylinder 44 again engages the blocking recess 40. A command may be issued to the PCB 76 to lock the carrier 18, i.e. to move the locking structure 54 from the unlocking position 84 to the locking position 56. Alternatively, the carrier 18 may be locked after a certain time limit.

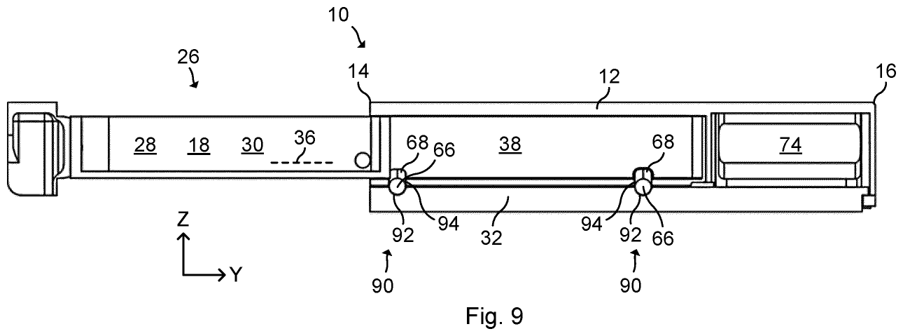

FIG. 9 schematically represents a partial cross-sectional side view of the storage device 10. In FIG. 9, the carrier 18 is in the open position 26 and the two locking bars 66 are in a released state 90.

As shown in FIG. 9, the base plate 32 comprises a securing structure, here exemplified as two grooves 92. Each locking bar 66 is associated with one of the grooves 92. Each groove 92 extends over the entire width of the base plate 32. Moreover, each groove 92 is aligned with the tracks 68 in the inner housing 38. In this example, also the outer housing 12 comprises a guiding structure for guiding the locking bars 66, here exemplified as four tracks 94 (only the two tracks 94 on one side are partly visible in FIG. 9).

The carrier 18 may optionally comprise an inclined surface, such as a chamfered edge. The chamfered edge may be provided at a distal end of the carrier 18, e.g. angled approximately 45 degrees relative to each of the XY-plane and the XY-plane.

In the released state 90 of the locking bars 66 in FIG. 9, where the locking bars 66 are free to move out from the associated grooves 92, the inner housing 38 and the outer housing 12 are allowed to be released from the base plate 32. Thus, in FIG. 9, the locking bars 66 are allowed to freely move (up and down in FIG. 9) in the tracks 94 in the outer housing 12 and in the tracks 68 in the inner housing 38. The storage device 10 can thereby be manually slid along the steps 72 of the base plate 32 until the storage device 10 is separated from the base plate 32 as one unit. In case the locking bars 66 are positioned in the grooves 92 (as shown in FIG. 9), relative movement between the rails 22 and the base plate 32 will cause the locking bars 66 to jump out from the grooves 92.

When the storage device 10 is separated from the base plate 32, the battery 74 is exposed (since it is no longer covered by the base plate 32. The battery 74 can thereby easily be accessed and replaced without needing tools.

When a fresh battery 74 has been installed, the storage device 10 can again be slid onto the base plate 32 into the position illustrated in FIG. 9. The carrier 18 can now be pushed into the inner housing 38 and the outer housing 12 to the right in FIG. 9. During this movement of the carrier 18, the carrier 18 will push the left locking bar 66 down in the left tracks 68, 94 until the left locking bar 66 engages the left groove 92 (if not already engaging the left groove 92). As the carrier 18 is moved further into the inner housing 38 and the outer housing 12, the carrier 18 will eventually also push the right locking bar 66 down in the tracks 68, 94 until the right locking bar 66 engages the right groove 92 (if not already engaging the right groove 92). The locking bars 66 thereby click into the grooves 92 and adopt a secured state. The locking bars 66 in this example thereby move downwards in FIG. 9, i.e. perpendicular to the carrier line 36 and parallel with a height direction of the carrier 18.

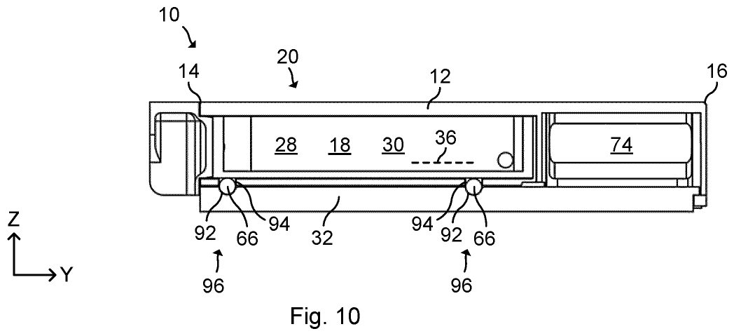

FIG. 10 schematically represents a partial cross-sectional side view of the storage device 10. In FIG. 10, the carrier 18 is in the closed position 20 and the two locking bars 66 are in a secured state 96. In the secured state 96, each locking bar 66 engages an associated groove 92 in the base plate 32. Moreover, the carrier 18 in the closed position 20 blocks the locking bars 66 in the secured state 96. Thus, screws for this purpose can be dispensed with.

Furthermore, as can be gathered from FIGS. 8 and 9, no springs are needed for moving the locking bars 66. Rather, the locking bars 66 can be moved to the secured state 96 by movement of the carrier 18 into the inner housing 38 and outer housing 12, and be moved to the released state 90 by movement of the rails 22 relative to the base plate 32.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

What is claimed is:

1. A storage device for storing a key, the storage device comprising:
a housing;
a blocking structure;
a carrier for carrying a key, the carrier being movable relative to the housing between a closed position, in which the carrier is accommodated within the housing, and an open position, in which the carrier at least partly protrudes from the housing for retrieval of a key from the carrier, the carrier comprising a blocking member and a biasing device arranged to bias the blocking member into engagement with the blocking structure in the closed position; and
an actuator comprising a locking structure, the actuator being arranged to move the locking structure between a locking position to lock the blocking member when engaging the blocking structure, and an unlocking position in which the blocking member is not locked by the locking structure.

2. The storage device according to claim 1, wherein the blocking member is arranged to be disengaged from the blocking structure by moving the carrier from the closed position towards the open position when the locking structure adopts the unlocking position.

3. The storage device according to claim 1, wherein the carrier comprises a seat, wherein the biasing device is arranged to bias the blocking member away from the seat, and wherein a free space for receiving the locking structure is established between the seat and the blocking member at least when the blocking member engages the blocking structure.

4. The storage device according to claim 1, wherein the biasing device comprises a spring.

5. The storage device according to claim 1, wherein the blocking member comprises an elongated and curved engaging surface arranged to engage the blocking structure.

6. The storage device according to claim 5, wherein the carrier is movable between the closed position and the open position along a carrier line, and wherein the engaging surface is elongated in a direction substantially perpendicular to the carrier line.

7. The storage device according to claim 1, wherein the blocking member is a cylinder.

8. The storage device according to claim 1, wherein a shape of the blocking structure substantially conforms to a shape of the blocking member.

9. The storage device according to claim 1, wherein the blocking structure is a blocking recess.

10. The storage device according to claim 1, wherein the carrier comprises a side wall, and wherein the blocking member protrudes with respect to the side wall when engaging the blocking structure.

11. The storage device according to claim 1, wherein the biasing device is arranged to bias the blocking member evenly into engagement with the blocking structure.

12. The storage device according to claim 1, wherein the housing comprises a holding structure, and wherein the biasing device is arranged to bias the blocking member into engagement with the holding structure in the open position.

13. A storage device for storing a key, the storage device comprising:
a base structure for being fastened to a wall or door, the base structure having a securing structure;
a housing;
at least one securing element arranged to adopt a released state where the housing is allowed to be released from the base structure by disengagement between the at least one securing element and the securing structure, and a secured state where the housing is secured to the base structure by engagement between the at least one securing element and the securing structure; and
a carrier for carrying a key, the carrier being movable relative to the housing between a closed position, in which the carrier is accommodated within the housing, and an open position, in which the carrier at least partly protrudes from the housing for retrieval of a key from the carrier,
wherein the at least one securing element is arranged to be switched from the released state to the secured state by movement of the carrier from the open position towards the closed position.

14. The storage device according to claim 13, wherein each of the at least one securing element comprises a locking bar.

15. The storage device according to claim 14, wherein the carrier is movable between the closed position and the open position along a carrier line, and wherein the at least one securing element is arranged to be moved to a secured position in a direction substantially perpendicular to the carrier line.
